(19) United States
(12) Patent Application Publication
(10) Pub. No.: US 2025/0034380 A1
(43) Pub. Date: Jan. 30, 2025

(54) POLYPROPYLENE COMPOSITION SUITABLE FOR PACKAGING APPLICATIONS

(71) Applicant: Borealis AG, Vienna (AT)

(72) Inventors: Jingbo Wang, Linz (AT); Markus Gahleitner, Linz (AT); Klaus Bernreitner, Linz (AT); Karlheinz Friedrich, Schwechat (AT); Claudia Kniesel, Linz (AT); Mahdi Abbasi, Linz (AT)

(21) Appl. No.: 18/711,748

(22) PCT Filed: Nov. 29, 2022
(86) PCT No.: PCT/EP2022/083613

§ 371 Date: May 20, 2024

(30) Foreign Application Priority Data
Dec. 1, 2021 (EP) 21211753.5

(51) Int. Cl. C08L 23/12

(52) U.S. Cl. CPC C08L 23/12; C08L 2203/30; C08L 2205/025; C08L 2205/03; C08L 2207/02; C08L 2314/06

(57) ABSTRACT

A composition obtainable by blending components (A) and (B) (A) 50 to 95 wt.-%, preferably 55 to 90 wt.-%, more preferably 60 to 88 wt.-% of a mixed-plastics polypropylene/polyethylene blend; and (B) 5 to 50 wt.-%. preferably 10 to 45 wt.-%, more preferably 12 to 40 wt.-% of a heterophasic propylene copolymer; whereby all percentages refer to the total composition; a process for producing said composition, an article comprising said composition, the use of said composition for the production of an article, and the use of component (B) in said composition for increasing melt flow rate MFR₂ (230° C. 2.16 kg. ISO1133) and the flexural modulus and reducing the VOC and FOG content of said composition.

The present invention relates to a high melt flow polypropylene composition with an improved balance of properties in regard of mechanical and impact properties, a process for producing said polypropylene composition, an article comprising said polypropylene composition and the use of said polypropylene composition for the production of an article.

### TECHNICAL BACKGROUND

Heterophasic propylene copolymers are widely used in the packaging industry, due to their excellent combination of stiffness and impact behaviour. One can find the application of heterophasic propylene copolymers in many aspects of daily life. One of the main application areas of polypropylene is to be found in injection molding of thin-wall articles. Typical examples include plastics cups, pails and small containers mainly intended for food packaging. In order to be suitable for thin-wall injection molding application, the polypropylene should demonstrate excellent processability/flowablity, normally expressed by high melt flow rate (MFR), i.e. low average molecular weight. Still, there is the desire within the polymer and packaging industry to improve the available heterophasic polypropylene compositions with high melt flow rates (MFR) in view of mechanical properties and especially the amount of impurities.

One of the fundamental problems in polymer business is recycling. At the moment, the market for recyclates, particularly recyclates from household trash, commonly denoted PCR (‘post-consumer recyclates’) is somewhat limited. Starting from household trash, the sorting and separation processes employed will not allow preparing pure polymers, i.e. there will always be some contaminants, or the processes may even result in blends of different polymers. When it comes to polyolefins, which constitute the vast majority of the polymer fraction of the collected household trash, a perfect separation of polypropylene and polyethylene is very difficult and cost-intensive. Recycled polyolefin materials, particularly post-consumer resins, are conventionally cross-contaminated with non-polyolefin materials such as polyethylene terephthalate, polyamide, polystyrene or non-polymeric substances like wood, paper, glass or aluminum. Even worse, those post-consumer recycled polyolefin materials are readily available on a multi-ton scale, but unfortunately have limited mechanical properties and frequently severe odor and/or emission problems.

For applications in the packaging industry materials are required, which combine good flowability, a low amount of impurities, and balanced mechanical properties in terms of stiffness and impact strength. Recently, the demand of the market has expanded in direction of using recycled polyolefins in blends with virgin polymers in order to fulfil specific requirements.

However, there is a deeply felt need for allowing the upcycling and reuse of post-consumer polyolefin recyclates in final products without health and safety hazards.

Non-published patent applications EP 21 178 566.2 and EP 21 178 547.2 are related to polypropylene compositions for exterior and interior automotive applications which contain mixed plastics polypropylene-based blends originating from post-consumer recycled polyolefin streams and inorganic fillers, such as talc. These compositions show a beneficial balance of mechanical properties and good flowabability. However, these compositions need rather high amounts of virgin polymers so that the amount of post-consumer recyclates is limited.

The present invention is based on the surprising finding that by carefully selecting the heterophasic propylene copolymer based virgin component in polypropylene based compositions, which contain mixed-plastics polypropylene/polyethylene blends originating from post-consumer recycled polyolefin streams, polypropylene based compositions with a superior balance of properties in regard of impact properties, mechanical properties, such as in flexural modulus, flowability, shown in a high melt flow rate, and a low amount of impurities exemplified in a low amount of VOC and FOG are obtained. These compositions comprise a high amount of mixed-plastics polypropylene/polyethylene blends originating from post-consumer recycled polyolefin streams. Thus, the compositions of the invention comprising mixed-plastics polypropylene/polyethylene blend originating from post-consumer recycled polyolefin streams qualify for injection moulding applications, especially in packaging applications, such as thin wall packaging applications, and can replace sophisticated heterophasic polypropylene copolymers.

### SUMMARY OF THE INVENTION

The present invention relates to a composition obtainable by blending components (A) and (B)
(A) 50 to 95 wt.-%, preferably 55 to 90 wt.-%, more preferably 60 to 88 wt.-% of a mixed-plastics polypropylene/polyethylene blend; and
(B) 5 to 50 wt.-%, preferably 10 to 45 wt.-%, more preferably 12 to 40 wt.-% of a heterophasic propylene copolymer; whereby all percentages refer to the total composition, and whereby
the mixed-plastics polypropylene/polyethylene blend (A) has
   a crystalline fraction (CF) content determined according to CRYSTEX QC analysis in the range from 85.0 to 96.0 wt.-%, preferably in the range from 86.5 to 95.5 wt.-%, and
   a soluble fraction (SF) content determined according to CRYSTEX QC analysis in the range from 4.0 to 15.0 wt.-%, preferably in the range from 4.5 to 13.5 wt.-%, whereby
   said crystalline fraction (CF) has an ethylene content (C2 (CF)), as determined by FT-IR spectroscopy calibrated by quantitative ¹³C-NMR spectroscopy, in the range from 11.0 to 55.0 wt.-%, preferably in the range of 20.0 to 49.5 wt.-%; and
   said soluble fraction (SF) has an intrinsic viscosity (iV (SF)) in the range from 0.9 to 2.1 dl/g, preferably in the range of 1.0 to 2.0 dl/g;
the heterophasic propylene copolymer (B) comprises a matrix phase and an elastomer phase dispersed therein and has
   a melt flow rate MFR₂ (230° C., 2.16 kg, ISO 1133) of 105 to 320 g/10 min, preferably 107 to 300 g/10 min, more preferably 110 to 280 g/10 min;
   a soluble fraction (SF) content determined according to CRYSTEX QC analysis in the range of 10.0 to 35.0 wt.-%, preferably in the range of 11.0 to 32.5 wt.-%, more preferably in the range of 12.0 to 30.0 wt.-%, and
   an intrinsic viscosity of said soluble fraction (iV (SF)) as measured in decalin according to DIN ISO 1628/1 at 135° C. of at least 2.0 dl/g, preferably in the range of 2.3 to 4.5 dl/g, more preferably in the range of 2.5 to 4.3 dl/g;
the composition has
   a melt flow rate MFR₂ (230° C., 2.16 kg, ISO 1133) of at least 9.0 g/10 min, preferably 9.5 to 100 g/10 min, more preferably 10.0 to 75 g/10 min.

Further, the present invention relates to a process for producing the composition as described above or below comprising the steps of:
a) Polymerizing propylene in the presence of a single-site catalyst system in a first polymerization reactor for producing a first propylene polymer fraction;
b) Transferring a polymerization mixture comprising the single site catalyst system and the first propylene polymer fraction from the first polymerization reactor to a second polymerization reactor;
c) Polymerizing propylene in the presence of the single-site catalyst system in the second polymerization reactor for producing a second propylene polymer fraction;
d) Transferring a polymerization mixture comprising the single site catalyst system and the first and second propylene polymer fractions from the second polymerization reactor to a third polymerization reactor;
e) Polymerizing propylene and ethylene in the presence of a single-site catalyst system in the third polymerization reactor for producing a third propylene-ethylene copolymer fraction;
f) Withdrawing a polymerization mixture comprising the single site catalyst system, the first and second propylene polymer fractions and the third propylene-ethylene copolymer fraction from the third polymerization reactor; and
g) Obtaining the heterophasic propylene copolymer (B) comprising the first and second propylene polymer fractions and the third propylene-ethylene copolymer fraction;
h) Blending 5 to 50 wt.-%, preferably 10 to 45 wt.-%, more preferably 12 to 40 wt.-% of the heterophasic propylene copolymer (B) with 50 to 95 wt.-%, preferably 55 to 90 wt.-%, more preferably 60 to 88 wt.-% of the mixed-plastics polypropylene/polyethylene blend (A).

Still further, the present invention relates to an article comprising the composition as described above or below.

Additionally, the present invention relates to the use of the composition as described above or below for the production of an article.

Finally, the present invention relates to the use of a heterophasic propylene copolymer having
a melt flow rate MFR₂ (230° C., 2.16 kg, ISO 1133) of 105 to 320 g/10 min, preferably 107 to 300 g/10 min, more preferably 110 to 280 g/10 min;
a soluble fraction (SF) content determined according to CRYSTEX QC analysis in the range of 10.0 to 35.0 wt.-%, preferably in the range of 11.0 to 32.5 wt.-%, more preferably in the range of 12.0 to 30.0 wt.-%, and
an intrinsic viscosity of said soluble fraction (iV (SF)) as measured in decalin according to DIN ISO 1628/1 at 135° C. of at least 2.0 dl/g, preferably in the range of 2.3 to 4.5 dl/g, more preferably in the range of 2.5 to 4.3 dl/g;

in a composition as described above or below for increasing melt flow rate MFR₂ (230° C., 2.16 kg, ISO1133) and the flexural modulus and reducing the VOC and FOG content of said composition.

### Definitions

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below. Unless clearly indicated otherwise, use of the terms “a,” “an,” and the like refers to one or more.

Mixed plastics is defined as the presence of low amounts of compounds usually not found in virgin polypropylene compositions such as polystyrenes, polyamides, polyesters, wood, paper, limonene, aldehydes, ketones, fatty acids, metals, and/or long term decomposition products of stabilizers. Virgin polypropylene blends denote blends as directly originating from the production process without intermediate use. As a matter of definition “mixed plastics” can be equated with detectable amounts of polystyrene and/or polyamide-6 and/or limonene and/or fatty acids.

Mixed plastics thereby can originate from both post-consumer waste and industrial waste, as opposed to virgin polymers. Post-consumer waste refers to objects having completed at least a first use cycle (or life cycle), i.e. having already served their first purpose. In contrast to that, industrial waste refers to manufacturing scrap, respectively conversion scrap, which does not normally reach a consumer.

It will be understood by those skilled in the art that a soluble fraction (SF) as obtained by CRYSTEX QC analysis having an intrinsic viscosity (iV (SF)) in the range from 0.9 to 2.1 dl/g is typically found in material from recycling streams. In a preferred aspect of the invention the soluble fraction (SF) as obtained by CRYSTEX QC analysis has an intrinsic viscosity (iV (SF)) in the range from 1.0 to 2.0 dl/g.

A polymer blend is a mixture of two or more polymeric components. In general, the blend can be prepared by mixing the two or more polymeric components. A suitable mixing procedure known in the art is post-polymerization blending.

Post-polymerization blending can be dry blending of polymeric components such as polymer powders and/or compounded polymer pellets or melt blending by melt mixing the polymeric components.

A propylene homopolymer is a polymer, which essentially consists of propylene monomer units. Due to impurities especially during commercial polymerization processes a propylene homopolymer can comprise up to 0.1 mol % comonomer units, preferably up to 0.05 mol % comonomer units and most preferably up to 0.01 mol % comonomer units.

“Polypropylene-polyethylene blend” refers to a composition containing both polypropylene and polyethylene, including also polypropylene copolymers as well as polyethylene copolymers. As a direct determination of the polypropylene content and polyethylene content is not possible, the weight ratio polypropylene to polyethylene of 20/80 to 80/20 denotes the equivalent ratio as determined from calibration by iPP and HDPE and determination by IR spectroscopy.

A polypropylene means a polymer being composed of units derived from propylene in an amount of more than 50 mol-%.

A polyethylene means a polymer being composed of units derived from ethylene in an amount of more than 50 mol-%.

The presence of a heterophasic nature can be easily determined by the number of glass transition points, like in dynamic-mechanical analysis (DMA), and/or high resolution microscopy, like scanning electron microscopy (SEM), transmission electron microscopy (TEM) or atomic force microscopy (AFM).

The term “XCS” refers to the xylene cold soluble fraction (XCS wt.-%) determined at 25° C. according to ISO 16152. The term “XCI” refers to the xylene cold insoluble fraction (XCI wt.-%) determined at 25° C. according to ISO 16152.

Reactor blend is a blend originating from the production in two or more reactors coupled in series or in a reactor having two or more reaction compartments. A reactor blend may alternatively result from blending in solution. A reactor blend stands in contrast to a compound as produced by melt extrusion.

If not indicated otherwise “%” refers to weight-% (wt.-%).

### DETAILED DESCRIPTION

### Composition

In a first aspect, the present invention relates to a composition obtainable by blending components (A) and (B)
(A) 50 to 95 wt.-%, preferably 55 to 90 wt.-%, more preferably 60 to 88 wt.-% of a mixed-plastics polypropylene/polyethylene blend; and
(B) 5 to 50 wt.-%, preferably 10 to 45 wt.-%, more preferably 12 to 40 wt.-% of a heterophasic propylene copolymer; whereby all percentages refer to the total composition, and whereby
the mixed-plastics polypropylene/polyethylene blend (A) has
   a crystalline fraction (CF) content determined according to CRYSTEX QC analysis in the range from 85.0 to 96.0 wt.-%, preferably in the range from 86.5 to 95.5 wt.-%, and
   a soluble fraction (SF) content determined according to CRYSTEX QC analysis in the range from 4.0 to 15.0 wt.-%, preferably in the range from 4.5 to 13.5 wt.-%, whereby
   said crystalline fraction (CF) has an ethylene content (C2 (CF)), as determined by FT-IR spectroscopy calibrated by quantitative 13C-NMR spectroscopy, in the range from 11.0 to 55.0 wt.-%, preferably in the range of 20.0 to 49.5 wt.-%; and
   said soluble fraction (SF) has an intrinsic viscosity (iV (SF)) in the range from 0.9 to 2.1 dl/g, preferably in the range of 1.0 to 2.0 dl/g;
the heterophasic propylene copolymer (B) comprises a matrix phase and an elastomer phase dispersed therein and has
   a melt flow rate MFR₂ (230° C., 2.16 kg, ISO 1133) of 105 to 320 g/10 min, preferably 107 to 300 g/10 min, more preferably 110 to 280 g/10 min;
   a soluble fraction (SF) content determined according to CRYSTEX QC analysis in the range of 10.0 to 35.0 wt.-%, preferably in the range of 11.0 to 32.5 wt.-%, more preferably in the range of 12.0 to 30.0 wt.-%, and
   an intrinsic viscosity of said soluble fraction (iV (SF)) as measured in decalin according to DIN ISO 1628/1 at 135° C. of at least 2.0 dl/g, preferably in the range of 2.3 to 4.5 dl/g, more preferably in the range of 2.5 to 4.3 dl/g;
the composition has
   a melt flow rate MFR₂ (230° C., 2.16 kg, ISO 1133) of at least 9.0 g/10 min, preferably 9.5 to 100 g/10 min, more preferably 10.0 to 75 g/10 min.

The composition according to the present invention has one or more of the following characteristics:

The composition has a melt flow rate MFR₂ (230° C., 2.16 kg, ISO 1133) of at least 9.0 g/10 min, preferably 9.5 to 100 g/10 min, more preferably 10.0 to 75 g/10 min.

The composition according to the invention preferably shows a superior balance of properties in regard of mechanical properties, such as in in regard of the flexural modulus, impact properties, flowability, as can be seen from the melt flow rate described above, and especially a low amount of impurities as can be seen from the VOC and FOG contents and fogging.

The composition preferably has a flexural modulus (FM) in the range of 800 to 1300 MPa, preferably in the range of 850 to 1200 MPa, more preferably in the range of 865 to 1050 MPa, determined according to ISO 178 on injection moulded test specimen (80×10×4 mm³) as produced according to EN ISO 1873-2.

Further, the composition preferably has a Charpy notched impact strength at 23° C. (CNIS, 23° C.) in the range of 5.0 to 25.0 KJ/m², preferably in the range of 5.5 to 20.0 kJ/m², determined according to ISO 179/eA on injection moulded test specimen (80×10×4 mm³) as produced according to EN ISO 1873-2.

It is preferred that the composition has a Charpy notched impact strength at 23° C., which meets the following in-equation in relation its melt flow rate MFR₂ (230° C., 2.16 kg, ISO 1133)

CNIS, 23° C. [KJ/m²]>7.8[KJ/m²]−0.17[kJ/m²/g/10 min]·MFR₂[g/10 min]

with
CNIS, 23° C. being the Charpy notched impact strength at 23° C. of the composition, determined according to ISO 179/eA on injection moulding test specimen (80×10×4 mm³) as produced according to EN ISO 1873-2, and
MFR₂ being the melt flow rate MFR₂ (230° C., 2.16 kg, ISO 1133) of the composition.

Still further, the composition preferably has a Charpy notched impact strength at −20° C. (CNIS, −20° C.) in the range of 1.7 to 5.0 KJ/m², preferably in the range of 1.9 to 4.0 KJ/m², determined according to ISO 179/eA on injection moulding test specimen (80×10×4 mm³) as produced according to EN ISO 1873-2.

Additionally, the compositions preferably has one or more, preferably all of the following properties:
a content of volatile organic compounds (VOC) of not more than 100 μg/g, preferably in the range of 5 to 95 μg/g, more preferably in the range of 10 to 90 μg/g, determined according to VDA 278; and/or
a content of semi-volatile organic compounds (FOG) of not more than 1100 μg/g, preferably in the range of 50 to 1050 μg/g, more preferably in the range of 80 to 1000 μg/g, determined according to VDA 278; and/or
an amount of fogging of not more than 5.0 mg, preferably in the range of 0.5 to 4.5 mg, determined according to DIN75201, Part B on 2 mm thick compression molded plaques.

The composition of the invention mandatorily comprises components (A) and (B) as described above or below in the accordantly described amounts.

The composition can optionally comprise additional polymeric components. In the case that further polymeric components are present, the amount of the polymeric components in the composition is usually not higher than 5 wt.-%, preferably not higher than 2 wt.-%, based on the total weight of the composition. The lower limit of the further polymeric components, if present, is usually at least 0.1 wt.-%, preferably 0.2 wt.-%, based on the total weight of the composition. It is, however, preferred that that the composition does not comprise further polymeric components, i.e. the amount of further polymeric components in the composition is 0 wt.-%.

In one embodiment the composition preferably does not comprise any inorganic fillers, such as talc, mica, wollastonite or glass fibers.

In another embodiment the composition preferably comprises inorganic fillers, such as talc, mica, wollastonite or glass fibers, preferably in an amount of 5 to 40 wt.-%, based on the total weight of the composition.

### Mixed-Plastics Polypropylene/Polyethylene Blend (A)

The mixed-plastics polypropylene/polyethylene blend (A) is suitably characterized by CRYSTEX QC analysis. In the CRYSTEX QC analysis, a crystalline fraction (CF) and a soluble fraction (SF) are obtained which can be quantified and analyzed in regard of the monomer and comonomer content as well as the intrinsic viscosity (iV).

The mixed-plastics polypropylene/polyethylene blend (A) shows the following properties in the CRYSTEX QC analysis:
a crystalline fraction (CF) content determined according to CRYSTEX QC analysis in the range from 85.0 to 96.0 wt.-%, preferably in the range from 86.5 to 95.5 wt.-%, and
a soluble fraction (SF) content determined according to CRYSTEX QC analysis in the range from 4.0 to 15.0 wt %, preferably in the range from 4.5 to 13.5 wt.-%.

Said crystalline fraction (CF) has one or more, preferably all of the following properties:
an ethylene content (C2 (CF)), as determined by FT-IR spectroscopy calibrated by quantitative ¹³C-NMR spectroscopy, in the range from 11.0 to 55.0 wt.-%, preferably in the range of 20.0 to 49.5 wt.-%; and/or
an intrinsic viscosity (iV (CF)), as measured in decalin according to DIN ISO 1628/1 at 135° C., preferably in the range from 1.0 to below 2.6 dl/g, more preferably in the range from 1.2 to 2.5 dl/g.

Said soluble fraction (SF) has one or more, preferably all of the following properties:
an ethylene content (C2 (SF)), as determined by FT-IR spectroscopy calibrated by quantitative 13C-NMR spectroscopy, preferably in the range from 20.0 to 55.0 wt.-%, preferably in the range from 22.0 to 50.0 wt.-%; and/or
an intrinsic viscosity (iV (SF)), as measured in decalin according DIN ISO 1628/1 at 135° C., in the range from 0.9 to 2.1 dl/g, preferably in the range from 1.0 to 2.0 dl/g.

Preferably, the mixed-plastics polypropylene/polyethylene blend (A) comprises polypropylene and polyethylene in a weight ratio of 20/80 to 80/20, preferably in a weight ratio of 25/75 to 75/25.

The mixed-plastics polypropylene/polyethylene blend (A) preferably comprises units derived from propylene in an amount of from 50.0 to 95.0 wt.-%, more preferably from 51.5 to 90.0 wt.-%, still more preferably from 53.0 to 75.0 wt.-%.

The mixed-plastics polypropylene/polyethylene blend (A) preferably comprises units derived from ethylene in an amount of from 5.0 to 50.0 wt.-%, more preferably from 10.0 to 48.5 wt.-%, still more preferably from 25.0 to 47.0 wt.-%.

Further, the mixed-plastics polypropylene/polyethylene blend (A) preferably has one or more, preferably all of the following properties:
a melt flow rate MFR₂ (230° C., 2.16 kg, ISO1133) of 5.0 to 50 g/10 min, preferably of 5.2 to 45 g/10 min, more preferably of 5.4 to 40 g/10 min; and/or
a limonene content as determined by using solid phase microextraction (HS-SPME-GC-MS): 0.1 to 50 ppm; and/or
a tensile modulus of from 800 to 1400 MPa, preferably from 850 to 1200 MPa; and/or
a Charpy notched impact strength at 23° C. (CNIS, 23° C.) of from 4.0 to 8.5 kJ/m², preferably from 5.0 to 8.0 KJ/m²; and/or
a Charpy notched impact strength at −20° C. (CNIS, −20° C.) of from 1.0 to 4.5 kJ/m², preferably from 1.5 to 4.0 KJ/m².

The mixed-plastics polypropylene/polyethylene blend (A) according to the present invention is preferably present in the form of pellets. Pelletization contributes to the low amounts of volatile substances.

### Heterophasic Propylene Copolymer (B)

The heterophasic polypropylene copolymer (B) comprises a matrix phase and an elastomeric phase dispersed therein.

The heterophasic propylene copolymer (B) is characterized by
a melt flow rate MFR₂ (230° C., 2.16 kg, ISO 1133) of 105 to 320 g/10 min, preferably 107 to 300 g/10 min, more preferably 110 to 280 g/10 min;
a soluble fraction (SF) content determined according to CRYSTEX QC analysis in the range of 10.0 wt.-% to 35.0 wt.-%, preferably in the range of 11.0 to 32.5 wt.-%, more preferably in the range of 12.0 to 30.0 wt.-%; and
an intrinsic viscosity of said soluble fraction, iV (SF), measured in decalin according to DIN ISO 1628/1 at 135° C., at least 2.0 dl/g, preferably in the range of 2.3 to 4.5 dl/g, more preferably in the range of 2.5 to 4.3 dl/g.

Preferably the heterophasic propylene copolymer (B) has one or more, preferably all, of the following properties:
a crystalline fraction (CF), determined according to CRYSTEX QC analysis in an amount in the range of 65.0 to 90.0 wt.-%, preferably in the range of 67.5 to 89.0 wt.-%, more preferably in the range of 70.0 to 88.0 wt.-%; and/or
an intrinsic viscosity of the crystalline fraction (iV (CF)) of not more than 1.2 dl/g, preferably in the range of 0.4 to 1.1 dl/g; and/or
an ethylene content of the crystalline fraction (C2 (CF)) of not more than 1.0 wt.-%, preferably in the range of 0 to 0.9 wt.-%, based on the total weight of the crystalline fraction (CF), as determined by FT-IR spectroscopy calibrated by quantitative 13C-NMR spectroscopy; and/or
an ethylene content of the soluble fraction (C2 (SF)) of 14.0 to 29.0 wt.-%, preferably in the range of 17.0 to 26.0 wt.-%, more preferably in the range of 19.0 to 24.0 wt.-%, based on the total weight of the soluble fraction (SF), as determined by FT-IR spectroscopy calibrated by quantitative ¹³C-NMR spectroscopy; and/or
a flexural modulus in the range of 800 to 1500 MPa, preferably in the range of 850 to 1450 MPa, determined according to ISO 178 on injection moulded test specimen (80×10×4 mm³) as produced according to EN ISO 1873-2; and/or
a total ethylene content in the range of 2.0 to 5.5 wt.-%, preferably in the range of 2.5 to 5.0 wt.-%, based on the total weight of the heterophasic propylene copolymer (B), as determined by FT-IR spectroscopy calibrated by quantitative 13C-NMR spectroscopy; and/or
a melting temperature in the range of 150 to 162° C., preferably in the range of 152 to 160° C., determined by DSC according to ISO 3146 (part 3, method C2); and/or
a crystallization temperature in the range of 110 to 130° C., preferably in the range of 115 to 125° C., determined by DSC according to ISO 3146 (part 3, method C2); and/or
a Charpy notched impact strength at 23° C. in the range of 2.5 to 15.0 KJ/m², preferably in the range of 3.0 to 12.0 KJ/m², determined according to ISO 179/eA on injection moulded test specimen (80×10×4 mm³) as produced according to EN ISO 1873-2; and/or
a content of volatile organic compounds (VOC) of not more than 50 μg/g, preferably not more than 40 μg/g, more preferably not more than 35 μg/g, determined according to VDA 278, and usually at least 2 μg/g, preferably at least 4 μg/g; and/or
a FOG content of not more than 300 μg/g, preferably not more than 250 μg/g, more preferably not more than 225 μg/g, and usually at least 20 μg/g, preferably at least 40 μg/g, determined according to VDA 278.

It is preferred that the heterophasic propylene copolymer (B) has a flexural modulus (FM), which meets the following in-equation in relation to the amount of soluble fraction (SF)

FM[MPa]>1550[MPa]−33.4[MPa/wt.-%]· amount (SF) [wt.-%],

preferably

FM[MPa]>1575[MPa]−33.4[MPa/wt.-%]· amount (SF) [wt.-%],

more preferably

FM[MPa]>1600[MPa]−33.4[MPa/wt.-%]· amount (SF) [wt.-%],

most preferably

FM[MPa]>1625[MPa]−33.4[MPa/wt.-%]· amount (SF) [wt.-%],

with
FM [MPa] is the flexural modulus of the heterophasic propylene copolymer (B) in MPa, and
amount (SF) [wt.-%] is the amount of the soluble fraction (SF) in the heterophasic propylene copolymer (B) in wt.-%.

It is preferred that the polypropylene composition has a Charpy notched impact strength at 23° C. (CNIS, 23° C.), which meets the following in-equation in relation to the melt flow rate (MFR₂)

CNIS, 23° C. [kg/m²]>10.0[kg/m²]−0.05[kg/m²/g/10 min]·MFR₂[g/10 min],

preferably

CNIS, 23° C. [kg/m²]>10.5[kg/m²]−0.05[kg/m²/g/10 min]·MFR₂[g/10 min],

more preferably

CNIS, 23° C. [kg/m²]>11.0[kg/m²]−0.05[kg/m²/g/10 min]·MFR₂[g/10 min],

most preferably

CNIS, 23° C. [kg/m²]>11.5[kg/m²]−0.05[kg/m²/g/10 min]·MFR₂[g/10 min].

It is preferred that the heterophasic propylene copolymer (B) consists of propylene units and ethylene units.

Although not measured the content of units derived from propylene (C3) in the soluble fraction (SF) preferably adds up to 100 wt.-% with the content of units derived from ethylene (C2) in the soluble fraction (SF).

The content of units derived from propylene (C3) in the soluble fraction (SF) is preferably 71.0 to 86.0 wt.-%, more preferably 74.0 to 83.0 wt.-%, still more preferably 76.0 to 81.0 wt.-%.

Although not measured the content of units derived from propylene (C3) in the crystalline fraction (CF) preferably adds up to 100 wt.-% with the content of units derived from ethylene (C2) in the crystalline fraction (CF).

The content of units derived from propylene (C3) in the crystalline fraction (CF) is preferably at least 99.0 wt.-%, more preferably 99.1 to 100 wt.-%.

The total content of units derived from propylene (C3) in the heterophasic propylene copolymer (B) is preferably 94.5 to 98.0 wt.-%, more preferably 95.0 to 97.5 wt.-%.

Such heterophasic propylene copolymers are preferably produced in accordance with the inventive process as described above or below in the presence of a single-site catalyst system.

### Additives

Additives are commonly used in the composition according to the present invention. Preferably, the additives are selected from one or more of antioxidant(s), UV stabilizer(s), slip agent(s), nucleating agent(s), pigment(s), lubricant(s), masterbatch polymer(s) and/or anti-fogging agents.

Additives are usually present in the composition in an amount of from 0.01 to 5.0 wt.-%, preferably in an amount of 0.05 to 3.5 wt.-%, based on the total composition.

### Process

In a further aspect the present invention relates to a process for producing the composition as described above or below comprising the steps of:
a) Polymerizing propylene in the presence of a single-site catalyst system in a first polymerization reactor for producing a first propylene polymer fraction;
b) Transferring a polymerization mixture comprising the single site catalyst system and the first propylene polymer fraction from the first polymerization reactor to a second polymerization reactor;
c) Polymerizing propylene in the presence of the single-site catalyst system in the second polymerization reactor for producing a second propylene polymer fraction;
d) Transferring a polymerization mixture comprising the single site catalyst system and the first and second propylene polymer fractions from the second polymerization reactor to a third polymerization reactor;
e) Polymerizing propylene and ethylene in the presence of a single-site catalyst system in the third polymerization reactor for producing a third propylene-ethylene copolymer fraction;
f) Withdrawing a polymerization mixture comprising the single site catalyst system, the first and second propylene polymer fractions and the third propylene-ethylene copolymer fraction from the third polymerization reactor; and
g) Obtaining the heterophasic propylene copolymer (B) comprising the first and second propylene polymer fractions and the third propylene-ethylene copolymer fraction;
h) Blending 5 to 50 wt.-%, preferably 10 to 45 wt.-%, more preferably 12 to 40 wt.-% of the heterophasic propylene copolymer (B) with 50 to 95 wt.-%, preferably 55 to 90 wt.-%, more preferably 60 to 88 wt.-% of the mixed-plastics polypropylene/polyethylene blend (A).

The first polymerization reactor preferably is a slurry phase reactor, such as a loop reactor.

It is preferred that the operating temperature in the first polymerization reactor, preferably the loop reactor, is in the range from 62 to 85° C., more preferably in the range from 65 to 82° C., still more preferably in the range from 67 to 80° C.

Typically, the pressure in the first polymerization reactor, preferably in the loop reactor, is in the range from 20 to 80 bar, preferably 30 to 70 bar, like 35 to 65 bar.

It is preferred that in the first polymerization reactor, preferably the loop reactor, a propylene homopolymer is produced. Thus, it is preferred that the first propylene polymer fraction is a propylene homopolymer fraction.

Preferably hydrogen is added in the first polymerization reactor in order to control the molecular weight, i.e. the melt flow rate MFR₂.

Preferably the hydrogen to propylene ratio (H2/C3 ratio) in the first polypropylene reactor, preferably the loop reactor, is in the range from 0.70 to 2.5 mol/kmol, more preferably 0.75 to 2.0 mol/kmol.

Due to the strong hydrogen response of the catalyst and the rather high amount of hydrogen the melt flow rate of the first propylene polymer fraction is very high. It is preferred that the first propylene polymer fraction has a melt flow rate MFR₂ (230° C., 2.16 kg, ISO 1133) in the range of 1000 to 15000 g/10 min, preferably in the range of 1100 to 13500 g/10 min, more preferably in the range of 1250 to 11500 g/10 min.

The second polymerization reactor preferably is a first gas phase reactor, such as a first fluidized bed gas phase reactor.

It is preferred that the operating temperature in the second polymerization reactor, preferably the first gas phase reactor, is in the range from 75 to 95° C., more preferably in the range from 78 to 92° C.

Typically, the pressure in the second polymerization reactor, preferably in the first gas phase reactor, is in the range from 5 to 50 bar, preferably 15 to 40 bar.

It is preferred that in the second polymerization reactor, preferably the first gas phase reactor, a propylene homopolymer is produced. Thus, it is preferred that the second propylene polymer fraction is a propylene homopolymer fraction.

Preferably hydrogen is added in the second polymerization reactor in order to control the molecular weight, i.e. the melt flow rate MFR₂.

Preferably the hydrogen to propylene ratio (H2/C3 ratio) in the second polypropylene reactor, preferably the first gas phase reactor, is in the range from 2.0 to 6.5 mol/kmol, more preferably 2.8 to 5.5 mol/kmol.

Due to the strong hydrogen response of the catalyst and the rather high amount of hydrogen the melt flow rate of the combined first and second propylene polymer fractions is very high.

It is preferred that the combined first and second propylene polymer fractions have a melt flow rate MFR₂ (230° C., 2.16 kg, ISO 1133) of at least 1000 g/10 min, preferably in the range 1200 to 9000 g/10 min, more preferably in the range of 1500 to 8000 g/10 min.

It is further preferred that the combined first and second propylene polymer fractions have fraction soluble in cold xylene at 25° C. (XCS) in an amount not more than 2.0 wt.-%, preferably in the range of 0.1 to 1.5 wt.-%, based on the total weight of the combined first and second propylene polymer fractions.

The third polymerization reactor preferably is a second gas phase reactor, such as a second fluidized bed gas phase reactor.

It is preferred that the operating temperature in the third polymerization reactor, preferably the second gas phase reactor, is in the range from 65 to 85° C., more preferably in the range from 68 to 82° C. Typically the operating temperature in third polymerization reactor is lower than the operating temperature in the second polymerization reactor.

Typically, the pressure in the third polymerization reactor, preferably in the second gas phase reactor, is in the range from 5 to 50 bar, preferably 15 to 40 bar.

In the third polymerization reactor, preferably the second gas phase reactor, a propylene ethylene copolymer is produced. Thus, the third propylene polymer fraction is a propylene ethylene copolymer fraction.

The ethylene to propylene ratio (C2/C3 ratio) in the third polymerization polymerization reactor, preferably the second gas phase reactor, is in the range from 700 to 1000 mol/kmol, more preferably 800 to 950 mol/kmol.

Due to the high ethylene to propylene ratio (C2/C3 ratio) the third propylene copolymer fraction preferably is an elastomeric block copolymer with propylene rich sections and ethylene rich sections.

Preferably hydrogen is added in the second polymerization reactor in order to control the molecular weight, i.e. the melt flow rate MFR₂.

Preferably the hydrogen to ethylene ratio (H2/C2 ratio) in the third polymerization reactor, preferably the second gas phase reactor, is in the range from 0.5 to 3.5 mol/kmol, more preferably 1.0 to 2.5 mol/kmol.

It is preferred that the combined first, second and third propylene polymer fractions have a melt flow rate MFR₂ (230° C., 2.16 kg, ISO 1133) of at least 150 g/10 min, preferably in the range 165 to 500 g/10 min, more preferably in the range of 175 to 400 g/10 min.

It is further preferred that the combined first, second and third propylene polymer fractions have fraction soluble in cold xylene at 25° C. (XCS) in an amount in the range of 8.0 to 32.0 wt.-%, preferably in the range of 9.0 to 30.0 wt.-%, more in the range of 10.0 to 28.0 wt.-%, based on the total weight of the heterophasic propylene copolymer (B), wherein the XCS fraction preferably has the following properties:
an intrinsic viscosity (iV (XCS)) of at least 2.2 dl/g, preferably in the range of 2.3 to 4.6 dl/g, more preferably in the range of 2.5 to 4.4 dl/g, and
an ethylene content (C2 (XCS)) in the range of 15.0 to 30.0 wt.-%, preferably in the range of 18.0 to 27.0 wt.-%, more preferably in the range of 20.0 to 25.0 wt.-%, based on the total weight of the soluble fraction (SF), as determined by FT-IR spectroscopy calibrated by quantitative 13C-NMR spectroscopy.

Further the combined first, second and third propylene polymer fractions preferably have a total comonomer content, preferably ethylene (C2) content in the range of 2.0 to 5.5 wt.-%, preferably in the range of 2.5 to 5.0 wt.-%, based on the total weight of the polypropylene composition, as determined by FT-IR spectroscopy calibrated by quantitative 13C-NMR spectroscopy.

The combined first, second and third propylene polymer fractions preferably form a heterophasic propylene copolymer.

The preparation of the first, second and third propylene polymer fractions can comprise in addition to the (main) polymerization stages in the at least three polymerization prior thereto a pre-polymerization in a pre-polymerization reactor upstream to the first polymerization reactor.

In the pre-polymerization reactor, a polypropylene is produced. The pre-polymerization is preferably conducted in the presence of the single-site polymerization catalyst system. According to this embodiment, the single-site polymerization catalyst system is introduced to the pre-polymerization step. However, this shall not exclude the option that at a later stage for instance further co-catalyst is added in the polymerization process, for instance in the first reactor. In one embodiment, all components of the single site catalyst are only added in the pre-polymerization reactor, if a pre-polymerization is applied.

The pre-polymerization reaction is typically conducted at a temperature of 0 to 60° C., preferably from 15 to 50° C., and more preferably from 20 to 45° C.

The pressure in the pre-polymerization reactor is not critical but must be sufficiently high to maintain the reaction mixture in liquid phase. Thus, the pressure may be from 20 to 100 bar, for example 30 to 70 bar.

In a preferred embodiment, the pre-polymerization is conducted as bulk slurry polymerization in liquid propylene, i.e. the liquid phase mainly comprises propylene, with optionally inert components dissolved therein.

It is possible to add other components also to the pre-polymerization stage. Thus, hydrogen may be added into the pre-polymerization stage to control the molecular weight of the polypropylene as is known in the art. Further, antistatic additives may be used to prevent the particles from adhering to each other or to the walls of the reactor.

The precise control of the pre-polymerization conditions and reaction parameters is within the skill of the art.

Due to the above defined process conditions in the pre-polymerization, preferably a mixture of the single site catalyst system and the polypropylene produced in the pre-polymerization reactor is obtained. Preferably, the single site catalyst system is (finely) dispersed in the polypropylene. In other words, the single site catalyst particles introduced in the pre-polymerization reactor are split into smaller fragments that are evenly distributed within the growing polypropylene. The sizes of the introduced single site catalyst particles as well as of the obtained fragments are not of essential relevance for the instant invention and within the skilled knowledge.

As mentioned above, if a pre-polymerization is used, subsequent to said pre-polymerization, the mixture of the single site catalyst and the polypropylene produced in the pre-polymerization reactor is transferred to the first polymerization reactor. Typically the total amount of the polypropylene produced in the pre-polymerization reactor in the first, second and third propylene polymer fractions is rather low and typically not more than 5.0 wt.-%, more preferably not more than 4.0 wt.-%, still more preferably in the range from 0.5 to 4.0 wt.-%, like in the range 1.0 of to 3.0 wt.-%.

In case that pre-polymerization is not used, propylene and the other ingredients such as the single site catalyst system are directly introduced into the first polymerization reactor.

The residence times of the polymerization mixtures in the different polymerization stages are adjusted to obtain the amounts of the first, second and third polymer fractions in the combined first, second and third polymer fractions.

Preferably the first propylene polymer fraction is present in an amount of from 40 to 60 wt.-%, more preferably from 45 to 55 wt.-%, based on the total weight of the combined first, second and third propylene polymer fractions. The amount of the polypropylene polypropylene produced in the pre-polymerization reactor, if present, is generally added to the amount of the first propylene polymer fraction.

Preferably the second propylene polymer fraction is present in an amount of from 25 to 45 wt.-%, more preferably from 30 to 40 wt.-%, based on the total weight of the combined first, second and third propylene polymer fractions.

Preferably the third propylene polymer fraction is present in an amount of from 10 to 30 wt.-%, more preferably from 15 to 25 wt.-%, based on the total weight of the combined first, second and third propylene polymer fractions.

### Catalyst System

The single site catalyst system according to the present invention may be any supported metallocene catalyst system suitable for the production of isotactic polypropylene.

It is preferred that the single site catalyst system comprises a metallocene complex, a co-catalyst system comprising a boron-containing co-catalyst and/or aluminoxane co-catalyst, and a silica support.

In particular, it is preferred that the single site catalyst system comprises (i) a metallocene complex of the general formula (I)

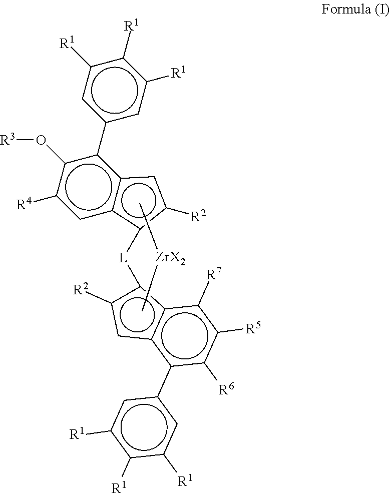

wherein
each X independently is a sigma-donor ligand,
L is a divalent bridge selected from —R′₂C—, —R′₂C—CR′₂—, —R′₂Si—, —R′₂Si—SiR′₂—, —
R′₂Ge—, wherein each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,
each R¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R² independently are the same or can be different and are a CH₂—R⁸ group, with R⁸ being H or linear or branched C₁₋₆-alkyl group, C₃₋₈-cycloalkyl group, C₆₋₁₀-aryl group,
R³ is a linear or branched C₁-C₆-alkyl group, C₇₋₂₀-arylalkyl, C₇₋₂₀-alkylaryl group or C₆-C20-aryl group,

R⁴ is a C(R⁹)₃ group, with R⁹ being a linear or branched C₁-C₆-alkyl group,

R⁵ is hydrogen or an aliphatic C₁-C₂₀-hydrocarbyl group optionally containing one or more heteroatoms from groups 14-16 of the periodic table;

R⁶ is hydrogen or an aliphatic C1-C20-hydrocarbyl group optionally containing one or more heteroatoms from groups 14-16 of the periodic table; or R⁵ and R⁶ can be taken together to form a 5 membered saturated carbon ring which is optionally substituted by n groups R¹⁰, n being from 0 to 4;

each R¹⁰ is same or different and may be a C₁-C₂₀-hydrocarbyl group, or a C₁-C₂₀-hydrocarbyl group optionally containing one or more heteroatoms belonging to groups 14-16 of the periodic table;

R⁷ is H or a linear or branched C₁-C₆-alkyl group or an aryl or heteroaryl group having 6 to 20 carbon atoms optionally substituted by one to three groups R¹¹,
each R¹¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group,
(ii) a co-catalyst system comprising a boron containing co-catalyst and/or an aluminoxane co-catalyst, and
(iii) a silica support.

The term “sigma-donor ligand” is well understood by the person skilled in the art, i.e. a group bound to the metal via a sigma bond. Thus the anionic ligands “X” can independently be halogen or be selected from the group consisting of R′, OR′, SiR′3, OSiR′₃, OSO₂CF₃, OCOR′, SR′, NR′₂ or PR′₂ group wherein R′ is independently hydrogen, a linear or branched, cyclic or acyclic, C₁ to C₂₀ alkyl, C₂ to C₂₀ alkenyl, C₂ to C₂₀ alkynyl, C₃ to C₁₂ cycloalkyl, C₆ to C₂₀ aryl, C₇ to C₂₀ arylalkyl, C₇ to C₂₀ alkylaryl, C₈ to C₂₀ arylalkenyl, in which the R′ group can optionally contain one or more heteroatoms belonging to groups 14 to 16. In a preferred embodiment the anionic ligands “X” are identical and either halogen, like C₁, or methyl or benzyl.

A preferred monovalent anionic ligand is halogen, in particular chlorine (C1).

Preferred metallocene complexes include:
rac-dimethylsilanediylbis [2-methyl-4-(3′,5′-dimethylphenyl)-5-methoxy-6-tert-butylinden-1-yl]zirconium dichloride,
rac-anti-dimethylsilanediyl [2-methyl-4-(4′-tert-butylphenyl)-inden-1-yl] [2-methyl-4-(4′-tertbutylphenyl)
5-methoxy-6-tert-butylinden-1-yl] zirconium dichloride,
rac-anti-dimethylsilanediyl [2-methyl-4-(4′-tert-butylphenyl)-inden-1-yl] [2-methyl-4-phenyl-5-methoxy-6-tert-butylinden-1-yl] zirconium dichloride,
rac-anti-dimethylsilanediyl [2-methyl-4-(3′,5′-tert-butylphenyl)-1,5,6,7-tetrahydro-sindacen-1-yl] [2-methyl-4-(3′,5′-dimethyl-phenyl)-5-methoxy-6-tert-butylinden-1-yl] zirconium dichloride,
rac-anti-dimethylsilanediyl [2-methyl-4,8-bis-(4′-tert-butylphenyl)-1,5,6,7-tetrahydro-sindacen-1-yl] [2-methyl-4-(3′,5′-dimethyl-phenyl)-5-methoxy-6-tert-butylinden-1-yl] zirconium dichloride,
rac-anti-dimethylsilanediyl [2-methyl-4,8-bis-(3′,5′-dimethylphenyl)-1,5,6,7-tetrahydro-s-indacen-1-yl] [2-methyl-4-(3′,5′-dimethylphenyl)-5-methoxy-6-tert-butylinden-1-yl] zirconium dichloride,
rac-anti-dimethylsilanediyl [2-methyl-4,8-bis-(3′,5′-dimethylphenyl)-1,5,6,7-tetrahydro-s-indacen-1-yl] [2-methyl-4-(3′,5′-5 ditert-butyl-phenyl)-5-methoxy-6-tert-butylinden-1-yl] zirconium dichloride.

Especially preferred is rac-anti-dimethylsilanediyl [2-methyl-4,8-bis-(3′,5′-dimethylphenyl)-1,5,6,7-tetrahydro-s indacen-1-yl] [2-methyl-4-(3′,5′-dimethylphenyl)-5-methoxy-6-tert-butylinden-1-yl] zirconium dichloride.

The ligands required to form the complexes and hence catalyst systems of the invention can be synthesised by any process and the skilled organic chemist would be able to devise various synthetic protocols for the manufacture of the necessary ligand materials. For Example WO2007/116034 discloses the necessary chemistry. Synthetic protocols can also generally be found in WO 2002/02576, WO 2011/135004, WO 2012/084961, WO 2012/001052, WO 2011/076780, WO 2015/158790 and WO 2018/122134. Especially reference is made to WO 2019/179959, in which the most preferred catalyst of the present invention is described.

### Cocatalyst

To form an active catalytic species it is normally necessary to employ a cocatalyst as is well known in the art.

According to the present invention a co-catalyst system comprising a boron containing co-catalyst and/or an aluminoxane co-catalyst is used in combination with the above defined metallocene catalyst complex.

The aluminoxane co-catalyst can be one of formula (II):

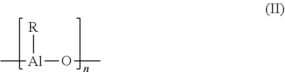

where n is usually from 6 to 20 and R has the meaning below.

Aluminoxanes are formed on partial hydrolysis of organoaluminum compounds, for example those of the formula AlR₃, AlR₂ Y and Al₂R₃ Y₃ where R can be, for example, C₁-C₁₀ alkyl, preferably C₁-C₅ alkyl, or C₃-C₁₀ cycloalkyl, C₇-C₁₂ arylalkyl or alkylaryl and/or phenyl or naphthyl, and where Y can be hydrogen, halogen, preferably chlorine or bromine, or C₁-C₁₀ alkoxy, preferably methoxy or ethoxy. The resulting oxygen-containing aluminoxanes are not in general pure compounds but mixtures of oligomers of the formula (II).

The preferred aluminoxane is methylaluminoxane (MAO). Since the aluminoxanes used as co-catalysts according to the invention are not, owing to their mode of preparation, pure compounds, the molarity of aluminoxane solutions hereinafter is based on their aluminium content.

According to the present invention, also a boron containing co-catalyst can be used instead of the aluminoxane co-catalyst or the aluminoxane co-catalyst can be used in combination with a boron containing co-catalyst.

It will be appreciated by the person skilled in the art that where boron based co-catalysts are employed, it is normal to pre-alkylate the complex by reaction thereof with an aluminium alkyl compound, such as TIBA. This procedure is well known and any suitable aluminium alkyl, e.g. Al(C₁-C₆ alkyl)₃ can be used. Preferred aluminium alkyl compounds are triethylaluminium, tri-isobutylaluminium, tri-isohexylaluminium, tri-n-octylaluminium and tri-isooctylaluminium.

Alternatively, when a borate co-catalyst is used, the metallocene catalyst complex is in its alkylated version, that is for example a dimethyl or dibenzyl metallocene catalyst complex can be used.

Boron based co-catalysts of interest include those of formula (III)

BY₃ (III)

wherein Y is the same or different and is a hydrogen atom, an alkyl group of from 1 to about 20 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred options are trifluoroborane, triphenylborane, tris(4-fluorophenyl) borane, tris(3,5-difluorophenyl) borane, tris(4-fluoromethylphenyl) borane, tris(2,4,6-trifluorophenyl) borane, tris(penta-fluorophenyl) borane, tris(tolyl) borane, tris(3,5-dimethyl-phenyl) borane, tris(3,5-difluorophenyl) borane and/or tris(3,4,5-trifluorophenyl) borane.

Particular preference is given to tris(pentafluorophenyl) borane.

However it is preferred that borates are used, i.e. compounds containing a borate 3+ion. Such ionic co-catalysts preferably contain a non-coordinating anion such as tetrakis(pentafluorophenyl) borate and tetraphenylborate. Suitable counterions are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

It has been surprisingly found that certain boron co-catalysts are especially preferred.

Preferred borates of use in the invention therefore comprise the trityl ion. Thus the use of N,N-dimethylammonium-tetrakispentafluorophenylborate and Ph₃CB(PhF₅)₄ and analogues therefore are especially favoured.

The preferred co-catalysts are aluminoxanes, more preferably methylaluminoxanes, combinations of aluminoxanes with Al-alkyls, boron or borate co-catalysts, and combination of aluminoxanes with boron-based co-catalysts.

The catalyst system of the invention is used in supported form. The particulate support material used is silica or a mixed oxide such as silica-alumina, in particular silica. The use of a silica support is preferred. The skilled practitioner is aware of the procedures required to support a metallocene catalyst.

In a preferred embodiment, the catalyst system corresponds to the ICS3 of WO 2020/239598 A1.

The process further comprises post reactor processing steps in which the polymer fractions are preferably separated from the polymerization mixture obtained from the last polymerization stage and blended in amounts of 5 to 50 wt.-%, preferably 10 to 45 wt.-%, more preferably 12 to 40 wt.-% of the heterophasic propylene copolymer (B) with 50 to 95 wt.-%, preferably 55 to 90 wt.-%, more preferably 60 to 88 wt.-% of the mixed-plastics polypropylene blend (A), optionally in the presence of other components such as further polymeric components and/or additives as described herein, to obtain the composition.

The blending step preferably is conducted by compounding the components in an extruded such as a twin-screw extruder using typical compounding conditions. The post reactor processing steps are well established in the art.

In one embodiment, the present invention is directed to a composition as described above that is obtainable, more preferably obtained, through the process as described herein. All preferable embodiments and fall back positions given for the composition above and below apply mutatis mutandis to the process of the invention.

### Article

In another aspect, the present invention relates to an article comprising the composition as described above or below.

The article preferably is a moulded article, such as an injection moulded article, fiber or mineral reinforced composite.

The article can be an automotive article comprising the composition as described above or below.

The article can also be a packaging article, preferably a thin wall packaging article, such as plastics cups, pales and small containers including lids for the same, e.g. intended for food packaging comprising the composition as described above or below.

In one embodiment, the composition of the article can comprise fibers, such as glass fibers or carbon fibers. In case fibers are present in the composition of the article, the amount of fibers is in the range of from 5 to 40 wt %, based on the composition of the article.

In another embodiment, the composition of the article can comprise mineral fillers, such as talc, mica or wollastonite. In case mineral fillers are present in the composition of the article, the amount of fillers is in the range of from 5 to 40 wt %, based on the composition of the article.

### Use

In yet another aspect, the present invention relates to the use of the composition as described above or below for the production of an article.

Further, the present invention relates to the use of heterophasic propylene copolymer having
a melt flow rate MFR₂ (230° C., 2.16 kg, ISO 1133) of 105 to 320 g/10 min, preferably 107 to 300 g/10 min, more preferably 110 to 280 g/10 min;
a soluble fraction (SF) content determined according to CRYSTEX QC analysis in the range of 10.0 to 35.0 wt.-%, preferably in the range of 11.0 to 32.5 wt.-%, more preferably in the range of 12.0 to 30.0 wt.-%, and
an intrinsic viscosity of said soluble fraction (iV (SF)) as measured in decalin according to DIN ISO 1628/1 at 135° C. of at least 2.0 dl/g, preferably in the range of 2.4 to 4.8 dl/g, more preferably in the range of 2.5 to 4.5 dl/g;
   in a composition as described above or below for increasing melt flow rate MFR₂ (230° C., 2.16 kg, ISO1133) and the flexural modulus and reducing the VOC and FOG content of said composition.

All preferable embodiments and fall back positions given for the heterophasic propylene copolymer (B), the composition and/or the article above and below apply mutatis mutandis to the uses of the invention.

### Experimental Section

The following Examples are included to demonstrate certain aspects and embodiments of the invention as described in the claims. It should be appreciated by those of skill in the art, however, that the following description is illustrative only and should not be taken in any way as a restriction of the invention.

### 1. Determination Methods

MFR₂ (230° C.) was measured according to ISO 1133 at 230° C. and 2.16 kg load.

### Crystex

Determination of Crystalline and Soluble Fractions and their Respective Properties (IV and Ethylene Content)

The crystalline (CF) and soluble fractions (SF) of the polypropylene (PP) compositions as well as the comonomer content and intrinsic viscosities of the respective fractions were analyzed by use of the CRYSTEX instrument, Polymer Char (Valencia, Spain). Details of the technique and the method can be found in literature (Ljiljana Jeremic, Andreas Albrecht, Martina Sandholzer & Markus Gahleitner (2020) Rapid characterization of high-impact ethylene-propylene copolymer composition by crystallization extraction separation: comparability to standard separation methods, International Journal of Polymer Analysis and Characterization, 25:8, 581-596)

The crystalline and amorphous fractions are separated through temperature cycles of dissolution at 160° C., crystallization at 40° C. and re-dissolution in 1,2,4-trichlorobenzene at 160° C. Quantification of SF and CF and determination of ethylene content (C2) are achieved by means of an integrated infrared detector (IR4) and for the determination of the intrinsic viscosity (iV) an online 2-capillary viscometer is used.

The IR4 detector is a multiple wavelength detector measuring IR absorbance at two different bands (CH₃ stretching vibration (centred at app. 2960 cm⁻¹) and the CH stretching vibration (2700-3000 cm⁻¹) that are serving for the determination of the concentration and the Ethylene content in Ethylene-Propylene copolymers. The IR4 detector is calibrated with series of 8 EP copolymers with known Ethylene content in the range of 2 wt.-% to 69 wt.-% (determined by ¹³C-NMR) and each at various concentrations, in the range of 2 and 13 mg/ml. To encounter for both features, concentration and ethylene content at the same time for various polymer concentrations expected during Crystex analyses the following calibration equations were applied:

$$Conc = a + b * Abs ( CH ) + c * {( Abs ( CH ) )}^{2} + d * Abs ( {CH}_{3} ) + e * ( {Abs ( {CH}_{3} )}^{2} + f * Abs ( CH ) * Abs ( {CH}_{3} ) \qquad ( Equation 1 )$$

$${CH}_{3} / 1000 C = a + b * Abs ( CH ) + c * Abs ( {CH}_{3} ) + d * ( Abs ( {CH}_{3} ) / Abs ( CH ) ) + e * {( Abs ( {CH}_{3} ) / Abs ( CH ) )}^{2} \qquad ( Equation 2 )$$

The constants a to e for equation 1 and a to f for equation 2 were determined by using least square regression analysis.

The CH₃/1000C is converted to the ethylene content in wt.-% using following relationship:

$$wt . \% ( Ethylene in EP Copolymers ) = 100 - {CH}_{3} / 1 \; 000 TC * 0.3 \qquad ( Equation 3 )$$

Amounts of Soluble Fraction (SF) and Crystalline Fraction (CF) are correlated through the XS calibration to the “Xylene Cold Soluble” (XCS) quantity and respectively Xylene Cold Insoluble (XCI) fractions, determined according to standard gravimetric method as per ISO16152. XS calibration is achieved by testing various EP copolymers with XS content in the range 2-31 wt.-%. The determined XS calibration is linear:

$$wt . - \% XS = 1 , 01 * wt \% SF \qquad ( Equation 4 )$$

Intrinsic viscosity (iV) of the parent EP copolymer and its soluble and crystalline fractions are determined with a use of an online 2-capillary viscometer and are correlated to corresponding iV's determined by standard method in decalin according to ISO 1628-3. Calibration is achieved with various EP PP copolymers with iV=2-4 dL/g. The determined calibration curve is linear:

$$iV ( dL / g ) = a * Vsp / c \qquad ( Equation 5 )$$

The samples to be analyzed are weighed out in concentrations of 10 mg/ml to 20 mg/ml. To avoid injecting possible gels and/or polymers which do not dissolve in TCB at 160° C., like PET and PA, the weighed out sample was packed into a stainless steel mesh MW 0,077/D 0,05 mmm.

After automated filling of the vial with 1,2,4-TCB containing 250 mg/l 2,6-tert-butyl-4-methylphenol (BHT) as antioxidant, the sample is dissolved at 160° C. until complete dissolution is achieved, usually for 60 min, with constant stirring of 400 rpm. To avoid sample degradation, the polymer solution is blanketed with the N2 atmosphere during dissolution.

A defined volume of the sample solution is injected into the column filled with inert support where the crystallization of the sample and separation of the soluble fraction from the crystalline part is taking place. This process is repeated two times. During the first injection the whole sample is measured at high temperature, determining the iV [dl/g] and the C2 [wt.-%] of the PP composition. During the second injection the soluble fraction (at low temperature) and the crystalline fraction (at high temperature) with the crystallization cycle are measured (wt.-% SF, wt.-% C2, iV).

The xylene cold solubles (XCS, wt.-%) were determined at 25° C. according to ISO 16152; first edition; 2005 Jul. 1.

Intrinsic viscosity was measured according to DIN ISO 1628/1, October 1999 (in Decalin at 135° C.).

### Quantification of Microstructure by NMR Spectroscopy-Ethylene Content in HECO

Quantitative nuclear-magnetic resonance (NMR) spectroscopy was used to quantify the comonomer content of the polymers. Quantitative ¹³C {¹H} NMR spectra were recorded in the solution-state using a Bruker Advance III 400 NMR spectrometer operating at 400.15 and 100.62 MHz for ¹H and ¹³C respectively. All spectra were recorded using a 13C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatary oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6k) transients were acquired per spectra. Quantitative 13C {1H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950). With characteristic signals corresponding to 2, 1 erythro regio defects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33 1157) the correction for the influence of the regio defects on determined properties was required. Characteristic signals corresponding to other types of regio defects were not observed.

The comonomer fraction was quantified using the method of Wang et. al. (Wang, W-J., Zhu, S., Macromolecules 33 (2000), 1157) through integration of multiple signals across the whole spectral region in the ¹³C {¹H} spectra. This method was chosen for its robust nature and ability to account for the presence of regio-defects when needed. Integral regions were slightly adjusted to increase applicability across the whole range of encountered comonomer contents.

For systems where only isolated ethylene in PPEPP sequences was observed the method of Wang et. al. was modified to reduce the influence of non-zero integrals of sites that are known to not be present. This approach reduced the overestimation of ethylene content for such systems and was achieved by reduction of the number of sites used to determine the absolute ethylene content to:

$$E = 0.5 ( S β β + S β γ + S β δ + 0.5 ( S α β + S α γ ) )$$

Through the use of this set of sites the corresponding integral equation becomes:

$$E = 0.5 ( {I}_{H} + {I}_{G} + 0.5 ( {I}_{C} + {I}_{D} ) )$$

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

$$E [ mol \% ] = 100 * fE$$

The weight percent comonomer incorporation was calculated from the mole fraction:

$$E [ wt \% ] = 100 * ( fE * 28.06 ) / ( ( fE * 28.06 ) + ( ( 1 - fE ) * 42. 08 ) )$$

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration regions slightly adjusted to increase applicability to a wider range of comonomer contents.

Flexural Modulus was determined in 3-point-bending according to ISO 178 on injection molded specimens of 80×10×4 mm³ injection molded according to EN ISO 1873-2.

Charpy Notched Impact Strength was determined according to ISO 179-1 eA at 23° C. and −20° C. on injection molded specimens of 80×10×4 mm³ injection molded according to EN ISO 1873-2.

DSC analysis, melting temperature (Tm) and crystallization temperature (Tc): measured with a TA Instrument Q2000 differential scanning calorimetry (DSC) on 5 to 7 mg samples. DSC is run according to ISO 11357/part 3/method C2 in a heat/cool/heat cycle with a scan rate of 10° C./min in the temperature range of −30° C. to +225° C. Crystallization temperature and crystallization enthalpy (Hc) are determined from the cooling step, while melting temperature and melting enthalpy (Hm) are determined from the second heating step.

VOC values and FOG values were measured according to VDA 278 (October 2011; Thermal Desorption Analysis of Organic Emissions for the Characterization of Non-Metallic Materials for Automobiles, VDA Verband der Automobilindustrie) after sample preparation of injection moulding plaques according to EN ISO 19069-2:2016. These plaques were packed in aluminium-composite foils immediately after production and the foils were sealed.

According to the VDA 278 October 2011 the VOC value is defined as “the total of the readily volatile to medium volatile substances. It is calculated as toluene equivalent. The method described in this recommendation allows substances in the boiling/elution range up to n-pentacosane (C₂₅) to be determined and analyzed.” The FOG value is defined as “the total of substances with low volatility, which elute from the retention time of n-tetradecane (inclusive)”. It is calculated as hexadecane equivalent. Substances in the boiling range of n-alkanes “C₁₄” to “C₃₂” are determined and analysed.

Fogging has been determined according to DIN75201, Part B on 2 mm thick compression molded plaques. Thermal treatment was performed at 100° C. for 16 hours. Fogging is expressed as a difference in weight before and after treatment.

### 1. Examples

Heterophasic propylene copolymers 1 and 2 (HECO1 and HECO2)

The catalyst used in the polymerization process for the heterophasic propylene copolymers 1 (HECO1) and 2 (HECO2) was Anti-dimethylsilanediyl [2-methyl-4,8-di(3,5-dimethylphenyl)-1,5,6,7-tetrahydro-s-indacen-1-yl] [2-methyl-4-(3,5-dimethylphenyl)-5-methoxy-6-tert-butylinden-1-yl] zirconium dichloride as disclosed in WO 2019/179959 A1 as MC-2. The supported metallocene catalyst was produced analogously to IE2 in WO 2019/179959 A1.

HECO1 and HECO2 were prepared in a Borstar PP pilot unit with sequential process comprising a prepolymerization reactor, a loop reactor and two gas phase reactors. The reaction conditions are summarized in Table 1.

TABLE 1
Preparation of HECO1 and HECO2

| | | HECO1 | HECO2 |
|---|---|---|---|
| Prepolymerization reactor | | | |
| | Temp. (° C.) | 20 | 20 |
| | Press. (bar(g)) | 55 | 55 |
| | H2/C3 (mol/kmol) | 0.07 | 0.07 |
| | Polymer residence time (h) | 0.3 | 0.3 |
| Loop reactor | | | |
| | Temp. (° C.) | 75 | 75 |
| | Press. (bar(g)) | 53 | 53 |
| | H2/C3 ratio (mol/kmol) | 1.31 | 0.80 |
| | XCS (wt.-%) | 1.90 | 1.10 |
| | MFR₂ (g/10 min) | 9470 | 1378 |
| | Productivity (kg PP/g cat) | 7.1 | 7.6 |
| | Polymer residence time (h) | 0.36 | 0.36 |
| | Polymer Split - prepol + loop (wt.-%) | 49 | 49 |
| 1^{st} GPR | | | |
| | Temp. (° C.) | 80 | 80 |
| | Press. (bar(g)) | 25 | 25 |
| | H2/C3 ratio (mol/kmol) | 4.64 | 3.00 |
| | XCS (wt.-%) | 0.20 | 0.70 |
| | MFR₂ (g/10 min) | 7170 | 1779 |
| | Productivity (kg PP/g cat) | 5.0 | 5.2 |
| | Polymer residence time (h) | 1.1 | 1.0 |
| | Polymer Split - 1^{st} GPR (wt.-%) | 34 | 31 |
| 2^{nd} GPR | | | |
| | Temp. (° C.) | 70 | 70 |
| | Press. (bar(g)) | 22 | 22 |
| | C2/C3 ratio (mol/kmol) | 888 | 854 |
| | H2/C2 ratio (mol/kmol) | 1.59 | 2.00 |
| | Productivity (kg PP/g cat) | 2.50 | 2.65 |
| | Polymer residence time (h) | 1.5 | 1.8 |
| | Polymer Split - 2^{nd} GPR (wt.-%) | 17 | 20 |
| Powder Properties | | | |
| | XCS (wt.-%) | 15.5 | 12.4 |
| | C2(XCS) (wt.-%) | 21.8 | 23.0 |
| | iV(XCS) (dl/g) | 3.5 | 2.5 |

For stabilization, the HECO1 and HECO2 were compounded each with 1500 ppm of Irganox B215 (a synergistic 2:1 blend of antioxidants Irgafos 168 (tris(2,4-ditert-butylphenyl) phosphite, CAS No: 31570-04-4) and Irganox 1010 (pentaerythritol tetrakis [3-[3,5-di-tert-butyl-4-hydroxyphenyl] propionate], CAS No: 6683-19-8), commercially available from BASF SE) and 500 ppm of calcium stearate (CAS No: 1592-23-0, commercially available from Bärlocher GmbH under the trade name CEASIT-1).

HECO3 used for comparative example CE3 is a copolymer based on a Ziegler-Natta type catalyst, identical to HECO3 of WO 2021144401 A1.

TABLE 2
Properties of HECO1, HECO2 and HECO3

| | | HECO1 | HECO2 | HECO3 |
|---|---|---|---|---|
| MFR₂ | g/10 min | 190 | 150 | 22 |
| C2 | wt.-% | 3.8 | 2.6 | 4.5 |
| iV | dl/g | 1.16 | 1.17 | 1.5 |
| SF | wt.-% | 16.9 | 12.1 | 16.0 |
| C2(SF) | wt.-% | 19.8 | 22.7 | 17.0 |
| iV(SF) | dl/g | 3.03 | 2.68 | 1.0 |
| CF | wt.-% | 83.1 | 87.9 | 84.0 |
| C2(CF) | wt.-% | 0.5 | 0 | 2.1 |
| iV(CF) | dl/g | 0.77 | 0.96 | 2.1 |
| iV(SF)/iV(CF) | | 3.94 | 2.79 | 0.48 |
| Tm | ° C. | 154 | 155 | 165 |
| Tc | ° C. | 119 | 118 | 116 |
| Hm | J/g | 88 | 93 | 87 |
| Flexural modulus (FM) | MPa | 1090 | 1248 | 1175 |
| Charpy NIS, 23° C. (CNIS) | kg/m² | 3.2 | 4.3 | 3.5 |
| VOC | μg/g | 25 | 6 | n.d. |
| FOG | μg/g | 201 | 53 | n.d. |
| FM - (1550 − 33.4 * SF) | MPa | 104 | 102 | 159 |
| CNIS - (10.0 − 0.05 * MFR₂) | kg/m² | 2.7 | 1.8 | −5.4 |

Propylene homopolymer 2 (PPH2)

PPH2 is a propylene homopolymer having a melt flow rate (230° C., 2.16 kg, ISO 1133) of 450 g/10 min, a flexural modulus of 1519 MPa, a VOC content of 267 μg/g and a FOG content of 629 μg/g, commercially available as HL504FB from Borealis AG.
Polypropylene/polyethylene blend

Table 3 shows the properties of the polypropylene/polyethylene blends (A) as used for the evaluation. As these compositions come from a mechanical recycling process, the properties are indicated as ranges.
Antioxidant masterbatch

Irganox B215 (a synergistic 2:1 blend of antioxidants Irgafos 168 (tris(2,4-ditert-butylphenyl) phosphite, CAS No: 31570-04-4) and Irganox 1010 (pentaerythritol tetrakis [3-[3,5-di-tert-butyl-4-hydroxyphenyl] propionate], CAS No: 6683-19-8), commercially available from BASF SE) was blended with propylene homopolmyer HC001, commercially available from Borealis AG to form an antioxidant masterbatch. In Table 4 the amounts of Irganox B215 and HC001 are given separately.

TABLE 3
Properties of Polypropylene/Polyethylene
Blends Mixtures (Blend A)

| | Blend A |
|---|---|
| PP/PE ratio | 55/45 |
| C2 (Blend A, total), wt.-% | 44.9 |
| Recycling origin | Yes, households |
| limonene | >0.1 ppm |
| MFR₂ (230° C., ISO1133), g/10 min | 5.7 |
| CF (CRYSTEX), wt % | 90.9 |
| iV (CF), dl/g | 1.9 |
| C2 (CF), wt % | 45.5 |
| SF (CRYSTEX), wt % | 9.1 |
| iV (SF), dl/g | 1.4 |
| C2 (SF), wt % | 46.0 |
| Tensile modulus, ISO 527-2, MPa | 900 |
| Charpy NIS + 23° C., ISO 179 1eA, kJ/m² | 6.5 |

The final compositions were compounded in a Coperion ZSK40 twin-screw extruder at 220° C. using the polymers together with the antioxidant masterbatch. The compositions of the examples are shown in Table 4.

TABLE 4
compositions of the examples

| | | CE1 | CE2 | CE3 | IE1 | IE2 | IE3 |
|---|---|---|---|---|---|---|---|
| Blend A | wt.-% | 99.0 | 69.0 | 69.0 | 69.0 | 84.0 | 69.0 |
| HECO1 | wt.-% | — | — | — | 30.0 | 15.0 | — |
| HECO2 | wt.-% | — | — | — | — | — | 30.0 |
| HECO3 | wt.-% | — | — | 30.0 | — | — | — |
| PPH2 | wt.-% | — | 30.0 | — | — | — | — |
| Irganox B215 | wt.-% | 0.2 | 0.2 | 0.2 | 0.2 | 0.2 | 0.2 |
| HC001 | wt.-% | 0.8 | 0.8 | 0.8 | 0.8 | 0.8 | 0.8 |

Table 5 shows the properties of the examples.

TABLE 5
Properties of the examples

| | | CE1 | CE2 | CE3 | IE1 | IE2 | IE3 |
|---|---|---|---|---|---|---|---|
| MFR2 | g/10 min | 5.7 | 24 | 8.5 | 18 | 10 | 16 |
| Flexural modulus | MPa | 866 | 1064 | 922 | 924 | 901 | 866 |
| Charpy NIS, 23° C. | kg/m² | 6.5 | 3.6 | 6.6 | 7.0 | 6.5 | 6.6 |
| Charpy NIS, −20° C. | kg/m³ | 2.1 | 1.6 | 2.8 | 2.0 | 2.0 | 2.2 |
| VOC | μg/g | 88 | 169 | 175 | 52 | 66 | 88 |
| FOG | μg/g | 973 | 946 | 986 | 783 | 870 | 973 |
| Fogging | mg | 4.32 | 3.93 | 4.42 | 3.26 | 3.75 | 4.30 |

It can be seen that the compositions according to the invention show improved impact properties, also at low temperatures, sufficient mechanical properties and a low amount of impurities in form of VOC, FOG and fogging. The compositions of the invention thus qualify for moulded articles for packaging purposes thereby comprising mixed plastics polypropylene blends obtained from post-consumer waste in amounts of up to 84 wt.-%.

1. A composition obtainable by blending components (A) and (B)
(A) 50 to 95 wt.-% of a mixed-plastics polypropylene/polyethylene blend; and
(B) 5 to 50 wt.-% of a heterophasic propylene copolymer; wherein all percentages refer to the total composition, and wherein
the mixed-plastics polypropylene/polyethylene blend (A) has
a crystalline fraction (CF) content determined according to CRYSTEX QC analysis in the range from 85.0 to 96.0 wt.-%, and
a soluble fraction (SF) content determined according to CRYSTEX QC analysis in the range from 4.0 to 15.0 wt.-%, wherein
the crystalline fraction (CF) has an ethylene content (C2 (CF)), as determined by FT-IR spectroscopy calibrated by quantitative ¹³C-NMR spectroscopy, in the range from 11.0 to 55.0 wt.-%; and
the soluble fraction (SF) has an intrinsic viscosity (iV (SF)) in the range from 0.9 to 2.1 dl/g;
the heterophasic propylene copolymer (B) comprises a matrix phase and an elastomer phase dispersed therein and has
a melt flow rate MFR₂ (230° C., 2.16 kg, ISO 1133) of 105 to 320 g/10 min;
a soluble fraction (SF) content determined according to CRYSTEX QC analysis in the range of 10.0 to 35.0 wt.-%, and
an intrinsic viscosity of the soluble fraction (iV (SF)) as measured in decalin according to DIN ISO 1628/1 at 135° C. of at least 2.0 dl/g;
the composition has
a melt flow rate MFR₂ (230° C., 2.16 kg, ISO 1133) of at least 9.0 g/10 min.

2. The composition according to claim 1 having a flexural modulus (FM) in the range of 800 to 1300 MPa determined according to ISO 178 on injection moulding test specimen (80×10×4 mm³) as produced according to EN ISO 1873-2.

3. The composition according to claim 1 having a Charpy notched impact strength at 23° C. in the range of 5.0 to 25.0 KJ/m², determined according to ISO 179/eA on injection moulding test specimen (80×10×4 mm³) as produced according to EN ISO 1873-2.

4. The composition according to claim 1 having a Charpy notched impact strength at 23° C., which meets the following in-equation in relation its melt flow rate MFR₂ (230° C., 2.16 kg, ISO 1133)
CNIS,23° C.[KJ/m²]>7.8[KJ/m²]−0.17[kJ/m²/g/10 min]·MFR₂[g/10 min]
with
CNIS, 23° C. being the Charpy notched impact strength at 23° C. of the composition, determined according to ISO 179/eA on injection moulding test specimen (80×10×4 mm³) as produced according to EN ISO 1873-2, and
MFR₂ being the melt flow rate MFR₂ (230° C., 2.16 kg, ISO 1133) of the composition.

5. The composition according to claim 1 having a Charpy notched impact strength at −20° C. in the range of 1.7 to 5.0 KJ/m² determined according to ISO 179/eA on injection moulding test specimen (80×10×4 mm³) as produced according to EN ISO 1873-2.

6. The composition according to claim 1 having one or more of the following properties:
a content of volatile organic compounds (VOC) of not more than 100 μg/g determined according to VDA 278; and/or
a FOG content of not more than 1100 μg/g determined according to VDA 278;
and/or
an amount of fogging of not more than 5.0 mg determined according to DIN75201, Part B on 2 mm thick compression molded plaques.

7. The composition according to claim 1 comprising additional polymeric components in an amount of up to 5 wt.-%.

8. The composition according to claim 1, wherein the mixed-plastics polypropylene/polyethylene blend (A) has one or more of the following properties:
an intrinsic viscosity of the crystalline fraction (iV (CF)), as measured in decalin according to DIN ISO 1628/1 at 135° C., in the range from 1.0 to below 2.6 dl/g;
an ethylene content of the soluble fraction (C2 (SF)), as determined by FT-IR spectroscopy calibrated by quantitative 13C-NMR spectroscopy, in the range from 20.0 to 55.0 wt.-%;
a melt flow rate MFR₂ (230° C., 2.16 kg, ISO1133) of 5.0 to 50 g/10 min of;
units derived from ethylene in an amount of from 5.0 to 50.0 wt.-%;
units derived from propylene in an amount of from 50.0 to 95.0 wt.-%;
a limonene content as determined by using solid phase microextraction (HS-SPME-GC-MS): 0.1 to 50 ppm; and/or
a tensile modulus of from 800 to 1400 MPa; and/or
a Charpy notched impact strength at 23° C. (CNIS, 23° C.) of from 4.0 to 8.5 kJ/m²; and/or
a Charpy notched impact strength at −20° C. (CNIS, −20° C.) of from 1.0 to 4.5 kJ/m².

9. The composition according to claim 1, wherein the heterophasic propylene copolymer (B) has one or more of the following properties:
a crystalline fraction (CF), determined according to CRYSTEX QC analysis in an amount in the range of 65.0 to 90.0 wt.-% based on the total weight of the heterophasic propylene copolymer (B);
an intrinsic viscosity of the crystalline fraction (iV (CF)) of not more than 1.2 dl/g;
an ethylene content of the crystalline fraction (C2 (CF)) of not more than 1.0 wt.-% based on the total weight of the crystalline fraction (CF), as determined by FT-IR spectroscopy calibrated by quantitative ¹³C-NMR spectroscopy;
an ethylene content of the soluble fraction (C2 (SF)) of 14.0 to 29.0 wt.-% based on the total weight of the soluble fraction (SF), as determined by FT-IR spectroscopy calibrated by quantitative ¹³C-NMR spectroscopy; and/or
a flexural modulus in the range of 800 to 1500 MPa determined according to ISO 178 on injection moulded test specimen (80×10×4 mm³) as produced according to EN ISO 1873-2;
a total ethylene content in the range of 2.0 to 5.5 wt.-% based on the total weight of the heterophasic propylene copolymer (B), as determined by FT-IR spectroscopy calibrated by quantitative ¹³C-NMR spectroscopy;
a melting temperature in the range of 150 to 162° C. determined by DSC according to ISO 3146 (part 3, method C2);
a crystallization temperature in the range of 110 to 130° C. determined by DSC according to ISO 3146 (part 3, method C2);
a Charpy notched impact strength at 23° C. in the range of 2.5 to 15.0 KJ/m² determined according to ISO 179/eA on injection moulded test specimen (80×10×4 mm³) as produced according to EN ISO 1873-2;
a content of volatile organic compounds (VOC) of not more than 50 μg/g determined according to VDA 278; and/or
a FOG content of not more than 300 μg/g determined according to VDA 278.

10. A process for producing the composition according to claim 1 comprising:
a) Polymerizing propylene in the presence of a single-site catalyst system in a first polymerization reactor for producing a first propylene polymer fraction;
b) Transferring a polymerization mixture comprising the single site catalyst system and the first propylene polymer fraction from the first polymerization reactor to a second polymerization reactor;
c) Polymerizing propylene in the presence of the single-site catalyst system in the second polymerization reactor for producing a second propylene polymer fraction;
d) Transferring a polymerization mixture comprising the single site catalyst system and the first and second propylene polymer fractions from the second polymerization reactor to a third polymerization reactor;
e) Polymerizing propylene and ethylene in the presence of a single-site catalyst system in the third polymerization reactor for producing a third propylene-ethylene copolymer fraction;
f) Withdrawing a polymerization mixture comprising the single site catalyst system, the first and second propylene polymer fractions and the third propylene-ethylene copolymer fraction from the third polymerization reactor; and
g) Obtaining the heterophasic propylene copolymer (B) comprising the first and second propylene polymer fractions and the third propylene-ethylene copolymer fraction;
h) Blending 5 to 50 wt.-% of the heterophasic propylene copolymer (B) with 50 to 95 wt.-% of the mixed-plastics polypropylene/polyethylene blend (A).

11. The process according to claim 10, wherein the single-site catalyst system (i) comprises a metallocene complex of the general formula (I) 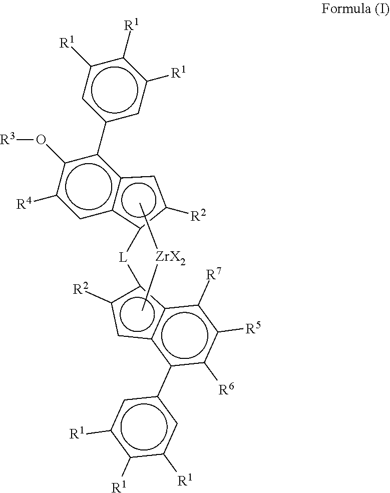
wherein
each X independently is a sigma-donor ligand,
L is a divalent bridge selected from —R′₂C—, —R′₂C—CR′₂—, —R′₂Si—, —R′₂Si—SiR′₂—, —R′₂Ge—, wherein each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,
each R¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R² independently are the same or can be different and are a CH₂—R⁸ group, with R⁸ being H or linear or branched C₁₋₆-alkyl group, C₃₋₈-cycloalkyl group, C₆₋₁₀-aryl group, R³ is a linear or branched C₁-C₆-alkyl group, C₇₋₂₀-arylalkyl, C₇₋₂₀-alkylaryl group or C₆-C₂₀-aryl group,
R⁴ is a C(R⁹)₃ group, with R⁹ being a linear or branched C₁-C₆-alkyl group,
R⁵ is hydrogen or an aliphatic C₁-C₂₀-hydrocarbyl group optionally containing one or more heteroatoms from groups 14-16 of the periodic table;
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and may be a C₁-C₂₀-hydrocarbyl group, or a C₁-C₂₀-hydrocarbyl group optionally containing one or more heteroatoms belonging to groups 14-16 of the periodic table;
R⁷ is H or a linear or branched C₁-C₆-alkyl group or an aryl or heteroaryl group having 6 to 20 carbon atoms optionally substituted by one to three groups R¹¹,
each R¹¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group,
(ii) an aluminoxane co-catalyst, and
(iii) a silica support.

12. An article comprising the composition according to claim 1.

13. The article according to claim 12 being an automotive article or a packaging article.

14. (canceled)

15. A method of increasing melt flow rate MFR₂ (230° C., 2.16 kg, ISO1133) and the flexural modulus and reducing the VOC and FOG content of a composition according to claim 1 by introducing a heterophasic propylene copolymer having
a melt flow rate MFR₂ (230° C., 2.16 kg, ISO 1133) of 105 to 320 g/10 min;
a soluble fraction (SF) content determined according to CRYSTEX QC analysis in the range of 10.0 to 35.0 wt.-%, and
an intrinsic viscosity of said soluble fraction (iV(SF)) as measured in decalin according to DIN ISO 1628/1 at 135° C. of at least 2.0 dl/g;
in the composition.
